(19) United States
(12) Patent Application Publication
(10) Pub. No.: US 2015/0046323 A1
(43) Pub. Date: Feb. 12, 2015

(54) METHOD AND SYSTEM FOR LOCAL EVALUATION OF COMPUTER

(71) Applicant: MasterCard International Incorporated, Purchase, NY (US)

(72) Inventor: Simon BLYTHE, Cambridgeshire (GB)

(73) Assignee: MASTERCARD INTERNATIONAL INCORPORATED, Purchase, NY (US)

(21) Appl. No.: 14/456,317

(22) Filed: Aug. 11, 2014

(30) Foreign Application Priority Data
Aug. 12, 2013 (GB) 1314419.1

(51) Int. Cl. G06Q 20/32; G06F 9/445; G06Q 20/34

(52) U.S. Cl. CPC G06Q 20/322; G06Q 20/341; G06F 8/65
USPC 705/41; 705/39

(57) ABSTRACT

A method of evaluating a software status of computer equipment comprises the following steps. Firstly, a local data connection is initiated between a mobile computing device and the computing equipment to be evaluated. Following this, a transaction is performed between the mobile computing device and the computing equipment. During this transaction, information is exchanged between the mobile computing device and the computing equipment relating to a current software status of the computing equipment or a preferred software status. This allows the current software status of the computing equipment can be evaluated. Suitable mobile computing devices and computing equipment are also provided.

### FIELD OF INVENTION

This invention relates to local evaluation of computer equipment. It is particularly relevant to evaluation and updating of terminal software in interaction between a mobile computing device and a terminal. Embodiments of the invention relate particularly to the use of transaction cards or transaction card proxies for evaluating and directly or indirectly updating terminal software in transaction card payment and banking systems, such as the EMV payment system.

### BACKGROUND OF INVENTION

EMV is a financial transaction system based around the use of contact and contactless transaction cards. In the EMV payment model, an issuing bank provides an account holding customer with a smart card (or other token) to use when making payments. An acquiring bank provides a merchant with a compatible terminal device to use when accepting payments. The term “terminal” here is considered to cover any device that interfaces directly with such a transaction card (e.g., an interface allowing user entry of a personal identification number (PIN) such as a PIN pad or PIN Entry Device (PED), or a POS terminal or ATM device comprising means such as these, to allow interaction with a transaction card).

The cardholder will generally have a direct relationship with the issuing bank, which will take responsibility for supply and management of the transaction card and for any application software loaded onto it. In the merchant space, there is much more diversity in terminal supply and management.

Merchant terminals may be supplied and managed directly by an original equipment manufacturer (OEM), who will then also take responsibility for fixing bugs in terminal software and for updating terminal capabilities. Some merchants will take responsibility for terminal management and for any patching required themselves. In other cases, terminal supply and management is handled by intermediaries, which provide varying levels of maintenance and support.

This diversity in terminal supply and maintenance models creates some risks for the overall terminal infrastructure. There is no single hub where all the terminals of a particular type can be located, interrogated or patched. When a new terminal attack or vulnerability is identified, there is no good way to identify the extent to which this has been addressed by patching.

It would be desirable to identify and rectify terminal vulnerabilities more effectively than at present without preventing existing models of terminal supply and maintenance.

### SUMMARY OF INVENTION

In a first aspect, the invention provides a method of evaluating a software status of computer equipment, comprising: initiating a local data connection between a mobile computing device and the computing equipment to be evaluated; performing a transaction between the mobile computing device and the computing equipment; and exchanging information between the mobile computing device and the computing equipment relating to a current software status of the computing equipment or a preferred software status, whereby the current software status of the computing equipment can be evaluated.

In a distributed and disparate system in which there are many interactions between mobile computing devices (such as transaction cards or transaction card proxies) and computing equipment (such as ATMs and other forms of POI terminal), this is found to be an exceptionally effective way to determine software status of computer equipment, and so to determine whether there are deficiencies in software updating and to identify how to remediate them.

Preferably, the mobile computing device comprises a software status database, and wherein exchanging information comprises adding the current software status of the computing equipment to the software status database.

In a further aspect, the invention provides a method of updating software by interaction of computer equipment with a mobile computing device, comprising evaluating a software status of computer equipment as described above, determining that the software status of the computer equipment is different from a software status associated with the mobile computing device, and updating the software status of the computer equipment or the software status associated with the mobile computing device.

This approach to software updating is extremely powerful, as in a system with frequent and varied transactions, the computer equipment will be updated relatively rapidly (particularly if it is heavily used, and so likely to require more rapid updating).

In one approach, updating the software status comprises sending a software update from one of the computer equipment and the mobile computing device to the other of the computer equipment and the mobile computing device. In another approach, updating the software status comprises sending an identifier from one of the computer equipment and the mobile computing device to the other of the computer equipment and the mobile computing device to allow a software update to be downloaded subsequently using the identifier. In a further approach, updating the software status comprises generating a prompt in the one of the computer equipment and the mobile computing device requiring a software update to contact a trusted source to obtain the software update.

In one preferred embodiment, the mobile computing device is a transaction device. The transaction may be a financial transaction, and the transaction device may be a transaction card. It may be a contact card, or it may be adapted to function as a contactless card.

Alternatively, the mobile computing device may be a transaction device which is a computing device adapted to function as a proxy for a payment card. Such a transaction device may be a mobile telephone.

Where the mobile computing device is a transaction device, particularly where the transaction is a financial transaction, the computing equipment may be a terminal of a financial transaction system. It may for example be a point of sale terminal, or an automated teller machine. In these cases, the software status of the computer equipment may comprise a state of an operating system of the terminal.

In a further aspect, the invention provides a mobile computing device adapted to evaluate a software status of computer equipment, comprising: means to initiate a local data connection with the computing equipment to be evaluated; and a processor programmed to perform a transaction between the mobile computing device and the computing equipment, and to obtain information relating to a current software status of the computing equipment, whereby the current software status of the computing equipment can be evaluated.

Preferably, the mobile computing device comprises a software status database, and obtaining information comprises adding the current software status of the computing equipment to the software status database.

Preferably the mobile computing device is further adapted for updating software of computer equipment, wherein the processor is programmed to determine whether the software status of the computer equipment is different from a software status associated with the mobile computing device, and if so to update the software status of the computer equipment or the software status associated with the mobile computing device.

In one approach, updating the software status comprises sending a software update to the computer equipment or receiving a software update from the computer equipment. In another approach, updating the software status comprises sending an identifier to the computer equipment or receiving an identifier from the computer equipment to allow a software update to be downloaded subsequently using the identifier. In a further approach, updating the software status comprises generating a prompt in the mobile computing device if requiring a software update to contact a trusted source to obtain the software update.

Preferably, the mobile computing device is a transaction device. The transaction may be a financial transaction, and the transaction device may be a transaction card. This may be a contact card, or may be adapted to function as a contactless card.

Alternatively, the mobile computing device may be a transaction device which is a computing device adapted to function as a proxy for a payment card. This may be a mobile telephone.

In embodiments, the mobile computing device further comprises a secure element for secure storage of sensitive data.

In a still further aspect, the invention provides computer equipment adapted such that its software status may be locally evaluated, comprising: means to initiate a local data connection with a mobile computing device; and a processor programmed to perform a transaction with the mobile computing device and to exchange information with the mobile computing device relating to a current software status of the computing equipment or a preferred software status, whereby the current software status of the computing equipment can be evaluated.

Preferably, the computer equipment is further adapted for its software status to be updated on interaction with the mobile computing device, wherein the processor is further programmed to determine whether the software status of the computer equipment is different from a software status associated with the mobile computing device, and if so to update the software status of the computer equipment or the software status associated with the mobile computing device.

Updating the software status may comprise any of the following: sending a software update to the mobile computing device or receiving a software update from the mobile computing device; sending an identifier to the mobile computing device or receiving an identifier from the mobile computing device to allow a software update to be downloaded subsequently using the identifier; or generating a prompt in the computer equipment if requiring a software update to contact a trusted source to obtain the software update.

In certain embodiments, the mobile computing device is a transaction device and the computer equipment is a terminal for a financial system, wherein the transaction is a financial transaction which the computer equipment is adapted to perform. The computer equipment may then further comprise a reader for a contact or a contactless transaction card. The computer equipment may be for example a point of sale terminal or an automated teller machine.

The software status of the computer equipment may comprise a state of an operating system of the terminal.

### BRIEF DESCRIPTION OF FIGURES

Embodiments of the invention will now be described, by way of example, with reference to the accompanying Figures, of which:

FIG. 1 shows an infrastructure in which embodiments of the invention may be used;

FIGS. 2a and 2b illustrate schematically respectively a payment card and mobile telephone used as a payment card proxy suitable for use in embodiments of the invention;

FIG. 3 illustrates schematically a terminal device suitable for use in embodiments of the invention;

FIG. 4 provides a flow diagram indicating steps of a method according to an aspect of the invention;

FIGS. 5a and 5b are block diagrams indicating an infrastructure using an embodiment of the invention; and

FIGS. 6a and 6b are flowcharts indicating an embodiment of a method according to the invention.

### DESCRIPTION OF SPECIFIC EMBODIMENTS

Specific embodiments of the invention will be described below with reference to the Figures.

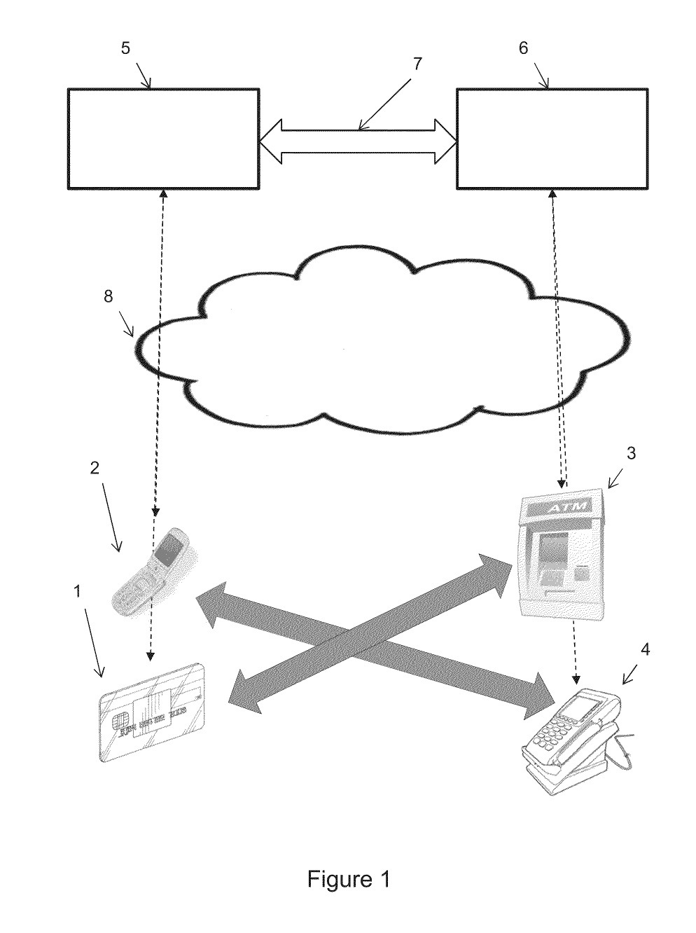

FIG. 1 shows an infrastructure in which embodiments of the invention may be used. The environment shown is a banking infrastructure, but embodiments of the invention may be employed in other computing infrastructures that have similar properties.

User computer devices are provided in the form of payment devices—these may be for example payment cards 1 or payment card proxies such as mobile phones 2. These devices have processors and memories for storing information including firmware and applications run by the respective processors. The devices also have means to enable local communication. These may comprise contacts on a payment card 1 to allow communication by protocols such as those defined under ISO/IEC 7816, they may comprise antennae and associated hardware and software to enable communication by NFC and associated contactless card protocols such as those defined under ISO/IEC 14443, or they may comprise an antenna and associated hardware and software to allow local wireless networking using 802.11 protocols or any combination of the above.

These user computer devices are mobile. Other computer equipment in the infrastructure is typically fixed, such as ATMs 3 and point-of-sale (POS) terminals 4. Such equipment is typically connected or connectable to an acquiring bank 5 or other service provider in a secure way (either through a dedicated channel or through a secure communication mechanism over a public or insecure channel—communication between equipment and an associated bank is shown as made through network cloud 8, representing any of these mechanisms). There may also be a mechanism to allow connection between the user computer devices and a card issuing bank 6 or service provider associated with the user. A banking infrastructure 7 will also connect the card issuer 6 and the acquiring bank 5, allowing transactions to be carried out between them.

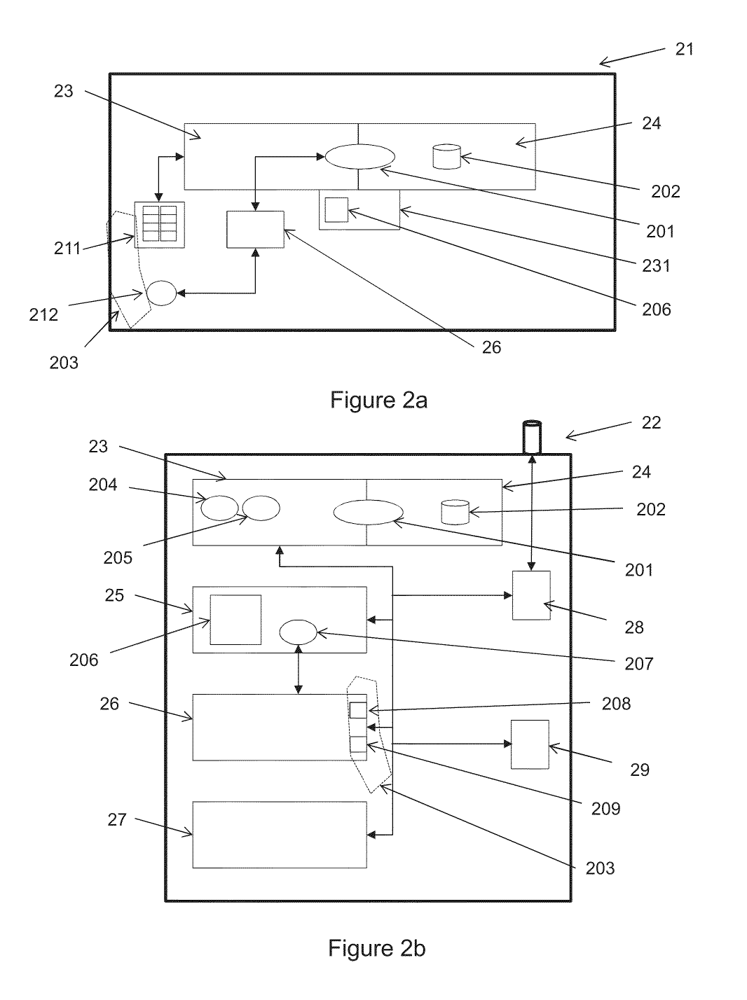

FIGS. 2a and 2b illustrate the functional features of payment devices for use in embodiments of the invention in more detail. FIG. 2a illustrates a payment card 21, whereas FIG. 2b illustrates a mobile telephone 22 as an example of a mobile computing device usable as a proxy for a payment card.

FIG. 2a shows schematically relevant parts of a representative hardware and software architecture for a transaction card such as a payment card 21 (particularly an EMV payment card) suitable for implementing an embodiment of the invention. The payment card 21 comprises an application processor 23, one or more memories 24 associated with the application processor and a NFC controller 26. Either within the application processor and memory structure or as a separate element there may be provided a security domain 206 adapted to support cryptographic actions—this is shown here as a part of a separate secure element 231. The payment card 21 is equipped with a contact pad 211 for contact transactions using contact card protocols such as ISO/IEC 7816 and also comprises an antenna 212 connected to NFC controller 26 to allow transactions under contactless card protocols such as those defined under ISO/IEC 14443.

In the arrangement shown, the application processor 23 and associated memories 24 comprise (shown within the processor space, but with code and data stored within the memories) the patch management application 201. The memories 24 contain the terminal patch database 202. The application processor 23 provides an NFC application 207 which interfaces with the NFC controller 26. The viral patch interface 203 may be established over a contact card interface, a contactless card interface, or any other communication channel available to the card for communicating with a terminal (either general purpose or dedicated to the purpose).

FIG. 2b shows schematically relevant parts of a representative hardware and software architecture for a mobile computing device suitable for implementing an embodiment of the invention. In the example shown, the mobile computing device is a mobile cellular telecommunications handset (“mobile phone” or “mobile device”)—in other embodiments, the computing device may be another type of computing device such as a laptop computer or a tablet, the computing device need not have cellular telecommunications capabilities, and one of the computing devices need not even be mobile (in principle, embodiments of the invention could be provided in which neither computing device were mobile, though in most practical applications envisaged at least one computing device would be mobile).

Mobile phone 22 comprises an application processor 23, one or more memories 24 associated with the application processor, a SIM or USIM 25 itself comprising both processing and memory capabilities and a NFC controller 26. The mobile phone also has a display controller 27 for a display, providing for example a touchscreen user interface. The mobile phone is equipped with wireless telecommunications apparatus 28 for communication with a wireless telecommunications network and local wireless communication apparatus 29 for interaction by NFC.

In the arrangement shown, the application processor 23 and associated memories 24 comprise (shown within the processor space, but with code and data stored within the memories) the patch management application 201. These will also contain other applications normally needed by such a device, such as a browser 204 and a modem 205. The memories 24 contain the terminal patch database 202. The SIM/USIM 25 will comprise a security domain 206 adapted to support cryptographic actions and an NFC application 207 which interfaces with the NFC controller 26, which has interfaces 208 to NFC devices and tags—this may also provide card emulation 209 to allow the mobile phone 1 to emulate a contactless card. The viral patch interface 203 may be established over any of these communication channels (or in principle over any other channel, either general purpose or dedicated to the purpose).

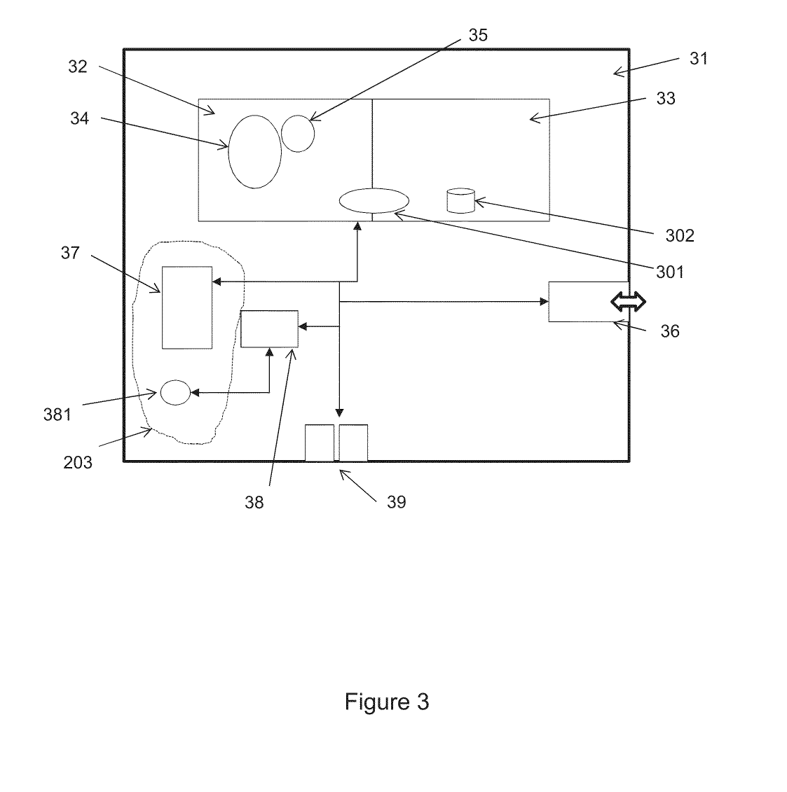

FIG. 3 illustrates the functional features of a terminal for use in embodiments of the invention in more detail. The terminal 31 has a processor 32 and associated memories 33. The base function of the terminal in the case shown is to operate as a point of interaction (POI) with a financial system—such a terminal may be a point of sale (POS) terminal or an automated teller machine (ATM) for example. In other embodiments, the terminal may have another function altogether (for example, a security system terminal for evaluating user credentials). In the case shown, the terminal 31 has an operating system 34 and transaction software 35 (these may be provided together in a single assemblage of code, or may both be divided into a number of different components, but are represented here as two elements for convenience). The operating system 34 manages hardware resources and provides common services for applications, whereas the transaction software 35 performs the base function of the terminal and may be provided (for example) as one or more applications. The terminal 32 will generally have a protected channel 36 to another party such as an acquiring bank (this may, for example, be effected over a public network by use of encryption), and will have means to make a connection to a device such as a transaction card. In this case, the terminal has a contact card reader 37 and an NFC controller 38 and antenna 381 to allow a contactless card connection to a contactless card, or a device such as an NFC-enabled mobile telephone able to act as a proxy for a contactless card. The terminal 31 may have additional ports 39 to allow data to be provided to it from other sources (for example, by USB stick).

The patch management application 301 is also run by the processor 32, and the memories 33 also store a patch management database 302. The viral patch interface 303 may be established through the contact card reader 37 or through the NFC controller 38, or indeed any other appropriate local connection.

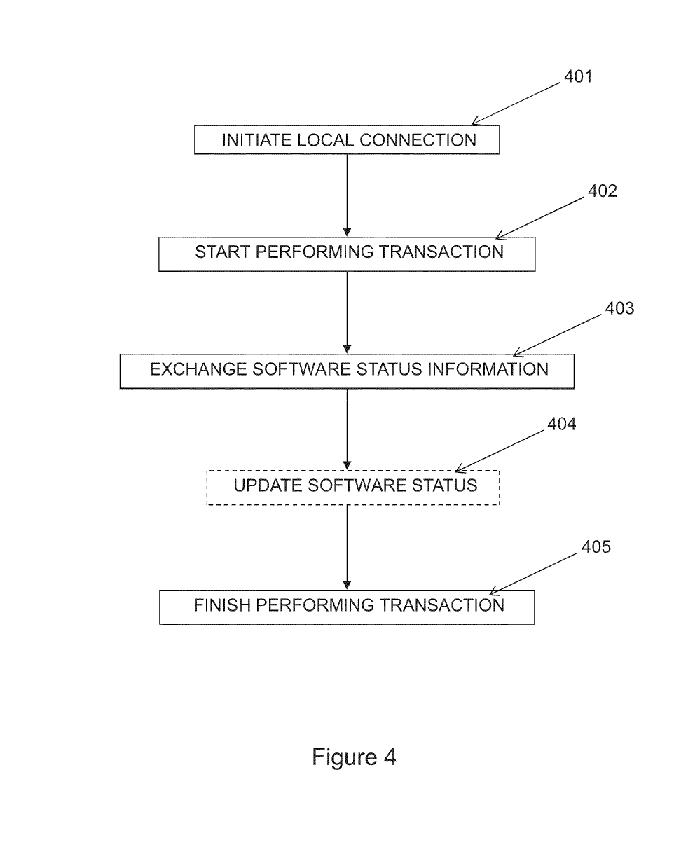

FIG. 4 sets out steps of a method according to an aspect of the invention. When considered generally, this method relates to a software status of computer equipment and its evaluation (and in some cases updating) by the agency of mobile computing devices. The first step 401 is to establish a local connection between the mobile computing device and the computer equipment. The next step 402 is to initiate a transaction between them. After this, the following step 403 shown is that of exchange of software status information between the mobile computing device and the computer equipment. The updating of a software status, following the software status exchange, is shown as an optional step 404. The finishing step 405 is shown as the completion of the transaction. While these steps are shown in linear succession in FIG. 4, it should be noted that once the local connection is established, the transaction and the exchange (and update) of software information may take place in parallel, or one after the other if more convenient. As discussed below with reference to specific embodiments, software status updating itself, and the process of determining whether software status updating is required, may be carried out as entirely separate processes or may be integrated into this process.

This method can be employed particularly effectively in the context of a financial payment infrastructure, as this involves a large population of terminals (computer equipment) which may be of different type and under different control, but which will typically be required to meet common standards (such as those specified for EMV-compliant devices). These terminals interact with an even larger and more diverse population of transaction cards and transaction card proxies. An ATM or a POS terminal may be involved in a hundred or more transactions with different transaction cards in a day. Under these conditions, the use of a viral mechanism to distribute software status information (and to upgrade software status, or to prompt or schedule such an upgrade) is extremely effective.

Such a mechanism is however also effective where the mobile computer device and the computer equipment are not associated with a payment infrastructure or a financial infrastructure of any type. For example, the computer equipment may be ticketing gates for a transport system, and the mobile computing devices may be smart tickets (for example, contactless cards or mobile telephones implementing NFC). In some transport systems, the same conditions apply—the ticketing gates may be of different age and provenance, and the most effective way to drive updates to ticketing gate software may be to use the tickets themselves to do so, virally. Other smart credentials (such as a passport) could potentially be used in the same way.

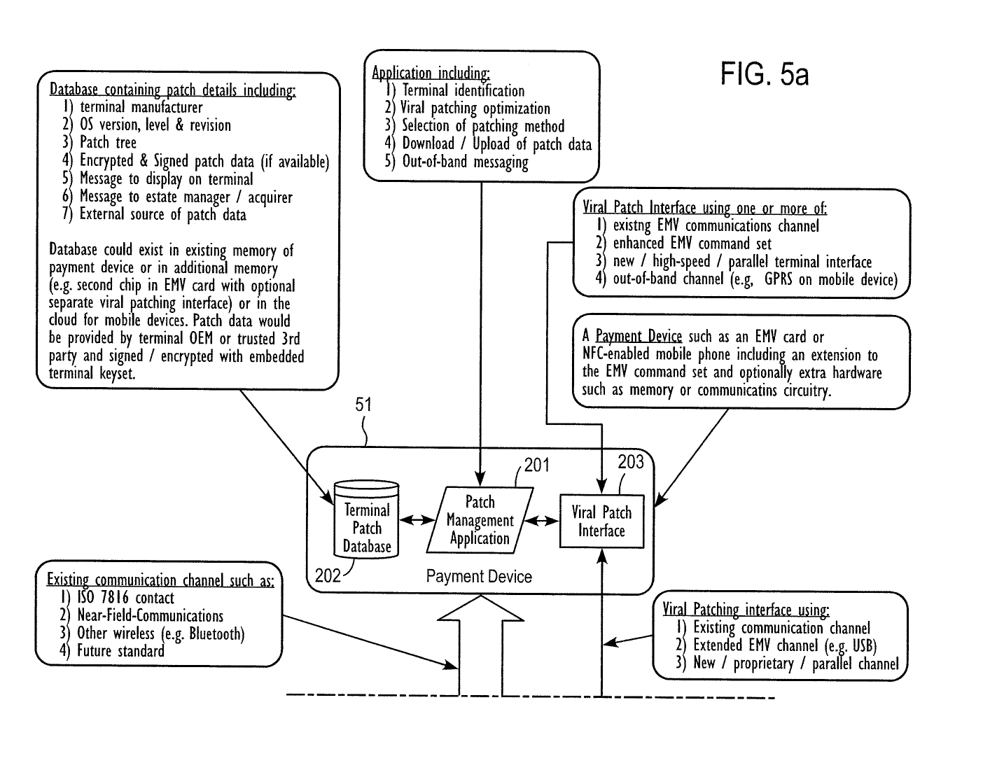

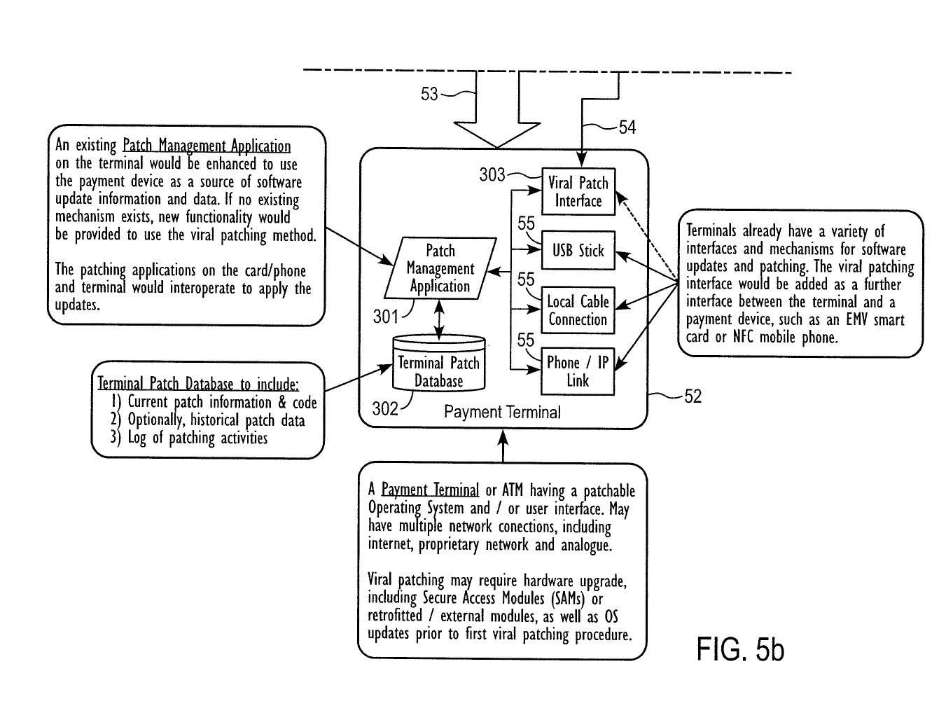

The functions of the different elements of the transaction device and terminal in an embodiment of the invention relating to EMV transactions are shown in FIGS. 5a and 5b. In this arrangement a transaction device is provided in the form of payment device 51 (which may be a payment card or a payment card proxy such as a mobile telephone) and a transaction terminal is provided in the form of a POI terminal 52. A conventional communication channel 53 is defined between the payment device 51 and POI terminal 52 supplemented by a viral patching channel 54 (which may be provide on, or separately from, the conventional communication channel 53).

The payment device 51 may be a payment card or an NFC-enabled mobile phone. In the embodiment described, it is implementing EMV protocols. To achieve viral patching functionality, the basis EMV command set may be expanded with additional commands relevant to viral patching, and additional memory or communications circuitry (for example, if a dedicated viral patching channel is required) may also be provided. The elements of the payment device relevant to viral patching are the patch management application 201, the terminal patch database 202 and the viral patch interface 203.

The patch management application 201 runs on the processor of the payment device and may use conventional payment device memories or additional memory used only for viral patching. The patch management application 201 is called when viral patching is a possibility—this will typically be when a local connection has been established with a POI terminal 52 (though this local connection need not necessarily be used for the viral patching interaction). It is responsible for identification (to the degree necessary) of the POI terminal 52, for determining whether viral patching is needed and if so what method of viral patching should be used, if there are alternatives available, and for download or upload of patch data if viral patching takes place. If out-of-band messaging is used for viral patching purposes, this is also under the control of the patch management application 201.

The terminal patch database 202 may be located in an existing transaction device memory, or may be in an additional memory (for example, an additional chip could be provided in the transaction card, possibly with its own communication channel for viral patching). The terminal patch database 202 contains the results of viral patching interactions, such as identification of terminals by terminal manufacturer and by operating system version, level and revision. Appropriate messages for display on the POI terminal and to be passed to the estate manager or acquirer associated with the POI terminal may also be provided. A patch tree may also be included—the terminal patch database 202 may also include or link to encrypted and signed patch data held by the payment device 51, or it may provide a link to an external source of such patch data. The patch data suitable for a specific POI terminal may be provided by the OEM of the POI terminal or by a trusted third party, and it may be signed and/or encrypted with an embedded keyset allowing verification and/or decryption by that POI terminal.

The viral patch interface 203 may use the existing EMV communications channel used in the local connection activating the patch management application 201—this local connection will generally also be carrying a payment transaction between the payment device 51 and the POI terminal 52. The viral patch information may for example be integrated into the EMV transaction by the use of an enhanced EMV command set including commands relevant to viral patching. Alternatively a new interface and a new channel may be used in parallel. An out-of-band channel (for example, the use of GPRS on a mobile telephone payment device) may for example be employed to separate the viral patching interaction from any financial transaction.

As indicated above, the viral patching channel 54, though shown here as separate to the existing communication channel 53 between the payment device 51 and the POI terminal 52, may in fact be implemented by the existing communication channel 53. This existing communication channel may be any of the options currently used for communication between payment devices and POI terminals (contact connection using ISO 7816, contactless connection using NFC or other wireless communication, such as other implementations of Bluetooth), or may use new communication types as these are developed. If implemented separately, the viral patching channel 54 may use a new channel (for example a new contact connection if the transaction card contains a new chip for viral patching) or some form of parallel channel. Another possibility would be for some communications to take place over the existing communication channel 53 (for example, commands in an enhanced EMV command set), with others taking place over a separate viral patching channel (such as transfers of sensitive data), perhaps using a USB connection or other separate communication protocol.

The POI terminal 52 (identified as Payment Terminal in FIGS. 5a and 5b, though this may also be a terminal such as an ATM) has an operating system and optionally application software using the operating system which are patchable. This terminal may have multiple network connections, typically including not only the local connections shown for the existing communication channel 53 but also a connection to other parties such as an acquirer bank associated with the POI terminal—this connection could be over the public internet or a proprietary network. Such additional connections 55 are shown in FIGS. 5a and 5b. The POI terminal 52 also has a patch management application 301, a terminal patch database 302 and a viral patch interface 303.

The POI terminal 52 will typically contain an existing application to allow patch management—the patch management application 301 may be provided either as a separate application or as an enhancement to such an existing application. The terminal patch management application 301 interactions with the payment device patch management application 201 to achieve viral patching, and also schedules implementation of any patch received on the POI terminal 52.

The terminal patch database 302 provides a record of the current software state of the POI terminal and of historical patching information—it may also contain or have access to the most recent patch code so that this can be provided to an interacting transaction device 51. The terminal patch database 302 preferably provides a log of all patching activities at the terminal.

The terminal viral patch interface 303 essentially mirrors the transaction card viral patch interface 203, allowing effective communication of viral patching data between the two.

Viral patching of the POI terminal 52 may require hardware upgrades to a conventional POI terminal—for example by inclusion of a secure access module to hold sensitive data or to manage sensitive communication. An operating system update may also be required before any first viral patching procedure.

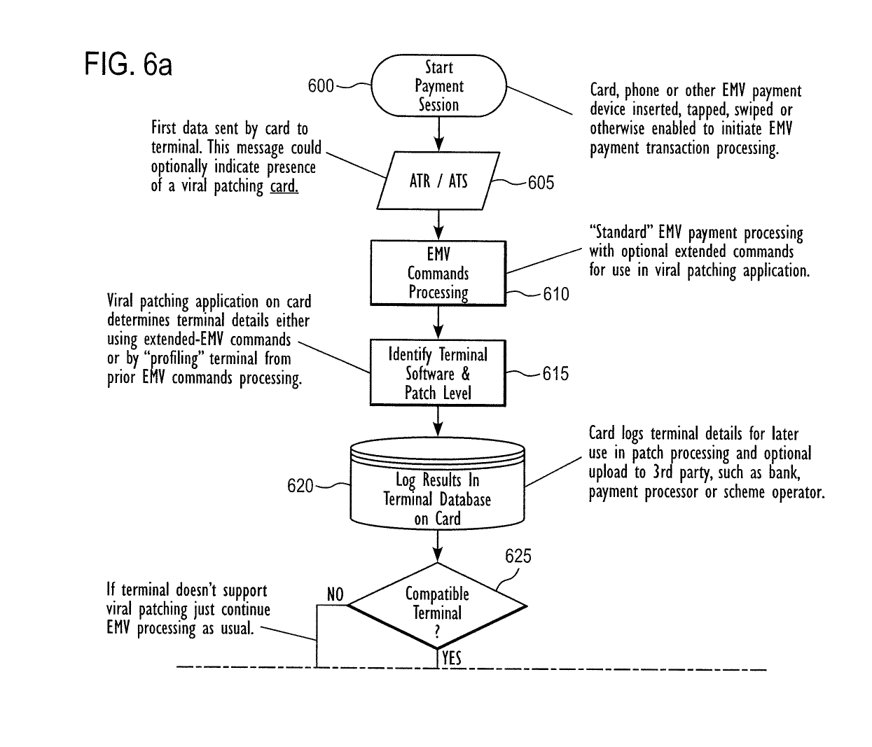

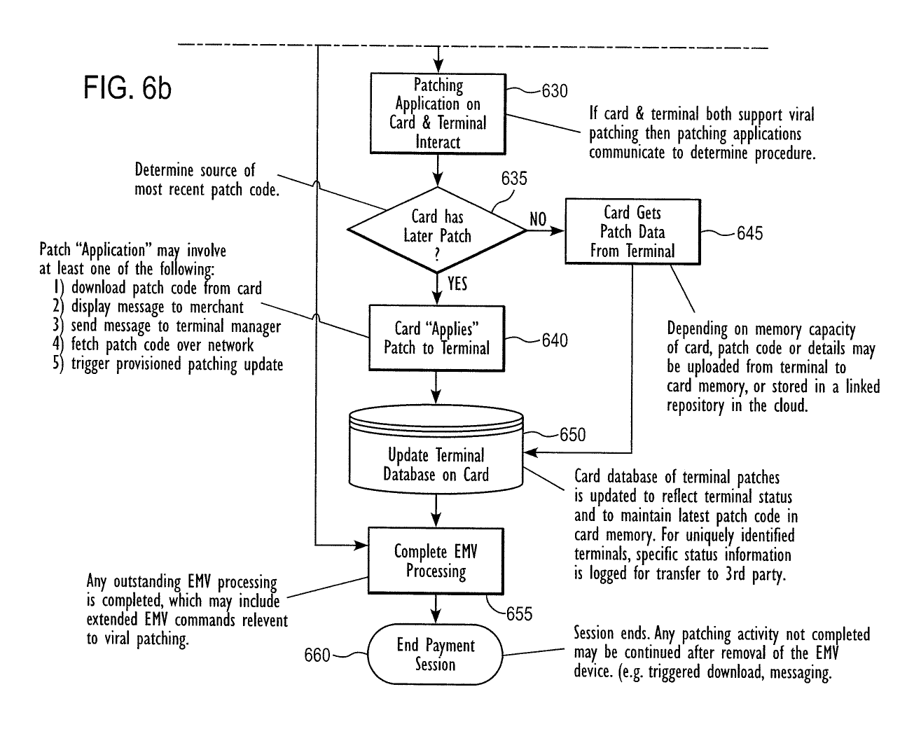

An exemplary implementation of a method according to an embodiment of the invention is shown in FIGS. 6A and 6B. The implementation is described for interaction of a transaction card with a POI terminal, but equivalent steps will be present if a transaction device is used as a proxy for a transaction card. The interaction will typically start with the start of a payment session 600. This may be by any conventional approach currently used to start a payment session, such as by inserting a transaction card into a POI terminal device to initiate a contact card transaction, or by tapping a transaction card against a POI terminal device to initiate a contactless card transaction, or by starting a mobile payment application and establishing a Bluetooth connection. In the context of an EMV payment transaction, essentially any method used to initiate an EMV payment session can be employed.

In step 605, the transaction card sends a message with its first data to the POI terminal. This message may be generally as required under EMV protocols to identify the card and initiate a transaction, but also includes in this implementation information to indicate that the transaction card is adapted for viral patching. This may be used as a trigger to initiate the viral patching application on the POI terminal, or to initiate any further authentication required to allow release of viral patching related data to the transaction card. Such authentication may use processes already used to establish that the card is under the control of its legitimate user, or they may be existing or new processes to establish that any viral patching related data received can be trusted or that the intended recipients of any viral patching related data provided by the POI terminal can be trusted.

In step 610, standard EMV payment processing begins. This is conventional, and will not be discussed any further here, save to note that the viral patching processes described here may be integrated with EMV payment processing by adding commands relating to viral patching to the EMV command set. Generally, the process of viral patching can be carried out in parallel to an EMV transaction.

In step 615 (optionally after establishing that this data can be released to the transaction card), the viral patching application on the transaction card obtains information from the POI terminal relevant to viral patching. This may include the software version used by the POI terminal and its patching history. This information may be obtained directly (for example, by new EMV commands that ask specifically for this information) or indirectly (for example, by “profiling” the POI terminal by analysing its processing of EMV commands and comparing it to known performance for POI terminals of the same type running different software versions.

In step 620, the transaction card logs the terminal state information obtained in the previous step in the terminal database stored on the card. This information may be used in subsequent patch processing, and in some arrangements may be held for transmission to a third party such as a bank, payment processor or scheme operator—such information could for example be transmitted to such a party in a transaction with a POI terminal controlled or trusted by that party, or could be transmitted in any transaction with a POI terminal connected to that party through a banking infrastructure after suitable encryption. In embodiments according to one aspect of the invention, patch processing may not occur and the monitoring of terminal state and subsequent reporting may be the only function carried out by the transaction card. Any subsequent updating or patching would then be carried out by the party controlling the POI terminal in the conventional way, but the use of transaction cards and devices to report on terminal state in this way may be used to provide a flow of information back to the POI terminal provider (for example, if a scheme operator determines that POI terminals controlled by a POI terminal provider are commonly unpatched or running old software versions, the scheme operator may advise the POI terminal provider to improve its updating policies, or there may be contractual sanctions if the POI terminal provider has contractual obligations to keep software up to date).

In embodiments in which viral patching itself can occur, it is necessary to determine (step 625) whether this is supported by the POI terminal. If not, normal EMV processing will continue (step 655 as described below) and no patching action (save the reporting back of terminal state) takes place. If both the transaction card and the POI terminal support viral patching, there will be an interaction step 630 between the two to determine the patching procedure (which may itself vary for different transaction device and POI terminal types or for different versions of the viral patching applications held on each device).

The first step within the viral patching application is to determine (step 635) whether the latest patch (or software version) is held by the POI terminal, the card, or whether the two are in the same position. If the patch status is the same for both the transaction card and the POI terminal, the only action needed is to update the terminal database (step 650) on the card (and possibly also a corresponding database of viral patching interactions at the POI terminal), if this has not been done already in step 615.

If the transaction card holds the latest version of the patch, this is then applied (step 640) to the POI terminal. This may be done in a number of different ways, depending on memory capacity on the card, communication speed and security, and trust. One approach is for the patch simply to be downloaded from the transaction card to the POI terminal. Another is for a message to be displayed to the merchant or sent to a POI terminal manager or controller that a new patch exists and should be applied. The patch code could then be fetched over the network. Another approach is simply for the finding that the transaction card possesses a newer patch to trigger a patching update in which the POI terminal reverts to its software provider to determine whether new patches are needed.

In preferred embodiments, it is possible also for the transaction card to be updated by the POI terminal. This allows viral processes to work most effectively, as the good practice of POI terminal managers who update and patch very regularly will be disseminated rapidly out into the wider POI terminal infrastructure. If the POI terminal has a later patch than the transaction card, the card receives data relating to this later patch (step 645) from the POI terminal. This data may be actual patch code if the transaction card has sufficient memory (and if the POI terminal is deemed to be a trustworthy source of such data), or may provide details which allow the patch to be downloaded from a linked depository available over the public internet or some other network.

After updating either the card or the terminal, the terminal database is updated (step 650) as indicated previously. After this step, the card will have the more recent of the versions of the patch held by the card or the terminal, and will also have terminal state information for provision to relevant parties linked to the card. This may either be general in form without identification of individual terminals, or may indicate the state of individual terminals. One possibility is for state information to be identified only for individual terminals with a specific association with the card issuer (in common ownership or with an appropriate contractual relationship).

As previously indicated, this viral patching activity may be carried out in parallel with normal EMV processing associated with a transaction. After this processing (including any viral patching commands) has been completed (step 655), the payment session ends (step 660). This does not necessarily end viral patching activity associated with the interaction, as some steps may have been deferred—for example, the POI terminal may have scheduled to download the patch at a regular download time, and the transaction card may add the terminal state information to a stack of messages to be sent to the card issuer next time a trusted information channel to the card issuer is established.

As the person skilled in the art will appreciate, modifications and variations to the above embodiments may be provided, and further embodiments may be developed, without departing from the spirit and scope of the invention. For example, while embodiments of the invention operate very effectively in the EMV banking infrastructure, embodiments of the invention may be used in other contexts altogether. In the case of the EMV banking infrastructure, the transaction is generally a financial transaction (though this need not be a payment—it may for example be a balance enquiry at an ATM) but in other embodiments, this need not be the case. For example, the user computing device may be a personal identification device such as a season ticket for a transportation system, and the transaction may be a determination by a terminal as to whether the ticket is valid to allow the bearer of the ticket to pass through a gate.

Reference to standards and proprietary technologies are provided for the purpose of describing effective implementations, and do not limit the scope of the invention.

1. A method of evaluating a software status of computer equipment, comprising:
initiating a local data connection between a mobile computing device and the computing equipment to be evaluated;
performing a transaction between the mobile computing device and the computing equipment; and
exchanging information between the mobile computing device and the computing equipment relating to a current software status of the computing equipment or a preferred software status, whereby the current software status of the computing equipment can be evaluated.

2. A method as claimed in claim 1, wherein the mobile computing device comprises a software status database, and wherein exchanging information comprises adding the current software status of the computing equipment to the software status database.

3. A method of updating software by interaction of computer equipment with a mobile computing device, comprising evaluating a software status of computer equipment as claimed in claim 1, determining that the software status of the computer equipment is different from a software status associated with the mobile computing device, and updating the software status of the computer equipment or the software status associated with the mobile computing device.

4. A method as claimed in claim 3, wherein updating the software status comprises one of the following steps: sending a software update from one of the computer equipment and the mobile computing device to the other of the computer equipment and the mobile computing device; sending an identifier from one of the computer equipment and the mobile computing device to the other of the computer equipment and the mobile computing device to allow a software update to be downloaded subsequently using the identifier; or generating a prompt in the one of the computer equipment and the mobile computing device requiring a software update to contact a trusted source to obtain the software update.

5. A method as claimed in claim 3, wherein the mobile computing device is a transaction device, and the transaction is a financial transaction.

6. A method as claimed in claim 5, wherein the transaction device is a transaction card, and the transaction card is adapted to function as a contact card, as a contactless card, or as both a contact card and a contactless card.

7. A method as claimed in claim 5, wherein the transaction device is a computing device adapted to function as a proxy for a payment card.

8. A method as claimed in claim 5, wherein the computing equipment is a terminal of a financial transaction system.

9. A mobile computing device adapted to evaluate a software status of computer equipment, comprising:
a local data connection mechanism to establish a local data connection with the computing equipment to be evaluated; and
a processor programmed to perform a transaction between the mobile computing device and the computing equipment, and to obtain information relating to a current software status of the computing equipment, whereby the current software status of the computing equipment can be evaluated.

10. A mobile computing device as claimed in claim 9, wherein the mobile computing device comprises a software status database, and wherein obtaining information comprises adding the current software status of the computing equipment to the software status database.

11. A mobile computing device as claimed in claim 9 and further adapted for updating software of computer equipment, wherein the processor is programmed to determine whether the software status of the computer equipment is different from a software status associated with the mobile computing device, and if so to update the software status of the computer equipment or the software status associated with the mobile computing device.

12. A mobile computing device as claimed in claim 11, wherein the processor is programmed to update the software status by one of the following steps: sending a software update to the computer equipment or receiving a software update from the computer equipment; sending an identifier to the computer equipment or receiving an identifier from the computer equipment to allow a software update to be downloaded subsequently using the identifier; or generating a prompt in the mobile computing device if requiring a software update to contact a trusted source to obtain the software update.

13. A mobile computing device as claimed in claim 9, wherein the mobile computing device is a transaction device, and wherein the transaction is a financial transaction.

14. A mobile computing device as claimed in claim 13, wherein the transaction device is a transaction card adapted to function as a contact card, as a contactless card, or as both a contact card and a contactless card.

15. A mobile computing device as claimed in claim 9, wherein the transaction device is a computing device adapted to function as a proxy for a payment card.

16. A mobile computing device as claimed in claim 9, wherein the transaction device is a cellular telecommunications handset.

17. A mobile computing device as claimed in claim 9, wherein the mobile computing device further comprises a secure element for secure storage of sensitive data.

18. Computer equipment adapted such that its software status may be locally evaluated, comprising:
a local data connection mechanism to establish a local data connection with a mobile computing device;
a processor programmed to perform a transaction with the mobile computing device and to exchange information with the mobile computing device relating to a current software status of the computing equipment or a preferred software status, whereby the current software status of the computing equipment can be evaluated.

19. Computer equipment as claimed in claim 18 and further adapted for its software status to be updated on interaction with the mobile computing device, wherein the processor is further programmed to determine whether the software status of the computer equipment is different from a software status associated with the mobile computing device, and if so to update the software status of the computer equipment or the software status associated with the mobile computing device.

20. Computer equipment as claimed in claim 18, wherein the mobile computing device is a transaction device and the computer equipment is a terminal for a financial system, wherein the transaction is a financial transaction which the computer equipment is adapted to perform, the computer equipment further comprising a reader for a contact or a contactless transaction card.
